(19) United States
(12) Patent Application Publication
(10) Pub. No.: US 2026/0358935 A1
(43) Pub. Date: Nov. 12, 2026

(54) HOME APPLIANCE CONTROL SYSTEM, OPERATION TERMINAL, AND SERVER

(71) Applicant: Mitsubishi Electric Corporation, Tokyo (JP)

(72) Inventors: Tadafumi KONDO, Tokyo (JP); Hiromitsu KANADA, Tokyo (JP); Yoshio HARADA, Tokyo (JP)

(21) Appl. No.: 19/121,634

(22) PCT Filed: Dec. 28, 2022
(86) PCT No.: PCT/JP2022/048576

§ 371 Date: Apr. 16, 2025

(51) Int. Cl. G06F 3/0484; F24F 11/52; G06F 3/04817

(52) U.S. Cl. CPC G06F 3/0484; F24F 11/52; G06F 3/04817

(57) ABSTRACT

A home appliance control system includes: a home appliance; an operation terminal including a display unit that displays a plurality of operation icons individually corresponding to a plurality of functions of the home appliance in association with control instruction information indicating execution of the functions; and a server that infers an operation frequency of each function with respect to the plurality of functions based on installation information of the home appliance including information regarding an environment of a location of the home appliance and information regarding a status of use of the home appliance, and determines display positions of the plurality of operation icons on the display unit based on the operation frequency of each function inferred.

### CROSS-REFERENCE TO RELATED APPLICATION

This application is a U.S. national stage application of PCT/JP2022/048576 filed Dec. 28, 2022, the contents of which are incorporated herein by reference.

### FIELD

The present disclosure relates to a home appliance control system that controls a home appliance, an operation terminal that implements the home appliance control system, and a server that implements the home appliance control system.

### BACKGROUND

Conventionally, operation terminals for home appliances such as remote controllers and smartphones have a significantly increasing number of functions capable of controlling working of the home appliances from the operation terminals. On the other hand, as the number of functions in the operation terminals increases, it becomes more difficult for the users to grasp functions convenient for the users.

For example, Patent Literature 1 proposes an operation terminal including: a display unit that displays a plurality of operation icons individually corresponding to functions; and a control unit that determines display positions of the plurality of operation icons on the display unit based on information on a magnitude relationship of the number of times each of the plurality of operation icons is selected and causes the display unit to display the plurality of operation icons, so that the functions of an air conditioner convenient for the user can be visually easily understood.

### PATENT LITERATURE

Patent Literature 1: PCT Patent Application Laid-open No. 2022/085184

However, according to the technique of patent Literature 1, the display positions of the plurality of operation icons are determined based on only the information on the magnitude relationship of the number of times each of the plurality of operation icons is selected. Therefore, the technique of Patent Literature 1 described above has a possibility that the priority of the display order of the operation icons of new functions capable of controlling the working of the air conditioner from the operation terminal or functions potentially suitable for the user is lowered among the plurality of operation icons displayed on the operation terminal.

### SUMMARY

The present disclosure has been made in view of the above, and an object thereof is to make it possible to present, to the user, functions of the home appliance that can be controlled from the operation terminal and are convenient for the user in a visually easily understandable manner when the user looks at the display unit of the operation terminal.

In order to solve the above-described problems and achieve the object, a home appliance control system in the present disclosure comprises: a home appliance; an operation terminal including a display unit to display a plurality of operation icons individually corresponding to a plurality of functions of the home appliance in association with control instruction information indicating execution of the functions; and a server to infer an operation frequency of each function with respect to the plurality of functions based on installation information of the home appliance including information regarding an environment of a location of the home appliance and information regarding a status of use of the home appliance, and determine display positions of the plurality of operation icons on the display unit based on the operation frequency of each function inferred.

The home appliance control system according to the present disclosure has an effect that, when the user looks at the display unit of the operation terminal, functions of the home appliance that can be controlled from the operation terminal and are convenient for the user can be presented to the user in a visually easily understandable manner.

### BRIEF DESCRIPTION OF DRAWINGS

FIG. 1 is a diagram illustrating a configuration of an air conditioning system according to the first embodiment.

FIG. 2 is a block diagram illustrating a configuration of the air conditioner in the air conditioning system according to the first embodiment.

FIG. 3 is a block diagram illustrating a configuration of the operation terminal in the air conditioning system according to the first embodiment.

FIG. 4 is a block diagram illustrating a configuration of the server in the air conditioning system according to the first embodiment.

FIG. 5 is a diagram illustrating a configuration of the learning device according to the first embodiment.

FIG. 6 is a diagram illustrating an example of learning data used when the learning device according to the first embodiment learns the operation frequency of the function of the air conditioner for function 1 of the air conditioner.

FIG. 7 is a diagram illustrating an example of learning data used when the learning device according to the first embodiment learns the operation frequency of the function of the air conditioner for function 2 of the air conditioner.

FIG. 8 is a diagram illustrating an example of learning data used when the learning device according to the first embodiment learns the operation frequency of the function of the air conditioner for function x of the air conditioner.

FIG. 9 is a flowchart illustrating a procedure for learning processing by the learning device according to the first embodiment.

FIG. 10 is a diagram illustrating an example of learning data in the model generation unit according to the first embodiment.

FIG. 11 is a diagram illustrating an example of post-format learning data which is the learning data into which the learning data illustrated in FIG. 10 is formatted.

FIG. 12 is a diagram illustrating an example of post-format learning data which is the learning data into which the learning data illustrated in FIG. 10 is formatted.

FIG. 13 is a diagram illustrating a configuration of the inference device according to the first embodiment.

FIG. 14 is a flowchart illustrating a procedure for inference processing by the inference device according to the first embodiment.

FIG. 15 is a diagram illustrating the icon display area of the operation screen displayed on the terminal display unit of the operation terminal according to the first embodiment.

FIG. 16 is an enlarged diagram illustrating the icon display area of the operation screen displayed on the terminal display unit illustrated in FIG. 15.

FIG. 17 is a diagram illustrating a function implementation setting screen displayed on the terminal display unit of the operation terminal according to the first embodiment.

FIG. 18 is a flowchart illustrating a procedure of an operation of automatic rearrangement of display of operation icons in the operation terminal of the air conditioning system according to the first embodiment.

FIG. 19 is a diagram illustrating an example of the device information and icon display position table stored in the terminal storage unit of the operation terminal according to the first embodiment.

FIG. 20 is a diagram indicating that the operation icons displayed in the icon display area of the terminal display unit have been automatically rearranged by the automatic rearrangement function of display of operation icons in the first embodiment.

FIG. 21 is a diagram illustrating an exemplary hardware configuration of the processing circuitry according to the first embodiment.

FIG. 22 is a block diagram illustrating an exemplary hardware configuration for implementing the operation terminal according to the first embodiment.

### DETAILED DESCRIPTION

Hereinafter, a home appliance control system, an operation terminal, and a server according to embodiments will be described in detail with reference to the drawings.

### First Embodiment

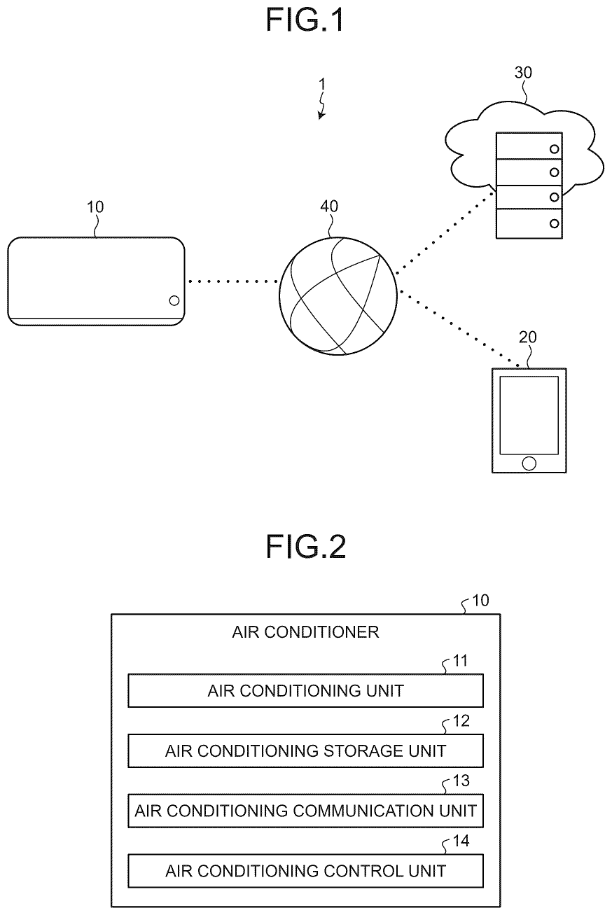

FIG. 1 is a diagram illustrating a configuration of an air conditioning system 1 according to the first embodiment. The air conditioning system 1 according to the first embodiment includes an air conditioner 10, an operation terminal 20, and a server 30. The air conditioner 10, the operation terminal 20, and the server 30 are connected to an Internet 40 which is a global information communication network, and can mutually transmit and receive information. In the air conditioning system 1, working control of the air conditioner 10 can be remotely operated by the operation terminal 20. That is, the air conditioning system 1 can be said to be a home appliance control system that includes the air conditioner 10 that is a home appliance as a control target device, the operation terminal 20 that remotely operates the working of the air conditioner 10 that is a home appliance, and the server 30, and can control the home appliance.

The air conditioner 10 is an air conditioner that performs air conditioning in a room that is a space to be air-conditioned, and is connected to the Internet 40 and can transmit and receive information to and from the operation terminal 20. As a result, the air conditioner 10 can acquire various types of information such as control instruction information for controlling the working of the air conditioner 10 from the operation terminal 20 via the Internet 40. That is, the operation terminal 20 can transmit various types of information such as control instruction information for controlling the working of the air conditioner 10 to the air conditioner 10 via the Internet 40.

The air conditioner 10 is connected to the Internet 40 and can transmit and receive information to and from the server 30. As a result, the air conditioner 10 can transmit various types of information such as working state information of the air conditioner 10 and model information to be described later to the server 30 via the Internet 40.

FIG. 2 is a block diagram illustrating a configuration of the air conditioner 10 in the air conditioning system 1 according to the first embodiment. The air conditioner 10 basically has a function of a general air conditioner, and performs air conditioning for an indoor space to be air-conditioned by the air conditioner 10. The air conditioner 10 includes an air conditioning unit 11, an air conditioning storage unit 12, an air conditioning communication unit 13, and an air conditioning control unit 14. These components of the air conditioner 10 can exchange information with each other.

The air conditioning unit 11 has an air conditioning function and a configuration in a general air conditioner. The air conditioning unit 11 includes a refrigerant circuit through which a refrigerant flows, a compressor that compresses the refrigerant in the refrigerant circuit, a heat exchanger that exchanges heat between air inside the room and the refrigerant flowing in the refrigerant circuit, a blower fan that sends conditioned air subjected to heat exchange in the heat exchanger into the room, a wind direction adjusting unit that adjusts a direction of sending the conditioned air, an outdoor heat exchanger that exchanges heat between air outside the room and the refrigerant flowing in the refrigerant circuit, and the like.

The air conditioning unit 11 includes an indoor temperature sensor (not illustrated) and an outdoor temperature sensor (not illustrated). The indoor temperature sensor measures an indoor temperature that is a temperature in a room that is a space to be air-conditioned at a predetermined cycle. The indoor temperature sensor transmits information on the measured indoor temperature to the air conditioning control unit 14. The outdoor temperature sensor is installed outdoors, and measures an outside air temperature that is a temperature of outside air that is outdoor air at a predetermined cycle. The outdoor temperature sensor transmits information on the measured outside air temperature to the air conditioning control unit 14.

The air conditioning storage unit 12 is a storage unit that stores various types of information on the inside of the air conditioner 10. The air conditioning storage unit 12 stores various types of information for use in the working of the air conditioner 10, including control instruction information for controlling the working of the air conditioner 10 transmitted from the operation terminal 20. That is, the air conditioning storage unit 12 stores various types of information such as control instruction information transmitted from the operation terminal 20 to the air conditioner 10 by the user operating an operation icon to be described later on the operation terminal 20. The air conditioning storage unit 12 also stores a control program for use in the control of the working of the air conditioner 10.

The air conditioning communication unit 13 is connected to the Internet 40 and communicates with the operation terminal 20. The air conditioning communication unit 13 is connected to the Internet 40 and communicates with the server 30.

The air conditioning control unit 14 controls the overall processing of the air conditioner 10. The air conditioning control unit 14 controls the running of the air conditioning unit 11 to control the working of the air conditioner 10. Then, the air conditioning control unit 14 controls the working of the air conditioner 10 in accordance with the control instruction information transmitted from the operation terminal 20. In addition, the air conditioning control unit 14 causes the air conditioning storage unit 12 to store various types of information such as control instruction information transmitted from the operation terminal 20 to the air conditioner 10 by the user operating an operation icon to be described later on the operation terminal 20. Upon receiving the device information request information indicating a request for the device information of the air conditioner 10 from the operation terminal 20, the air conditioning control unit 14 transmits the device information of the air conditioner 10 to the operation terminal 20.

The device information is information including name information of a function of the air conditioner 10 and function state information of the air conditioner 10.

The name information of the function is information indicating the name of the function of the air conditioner 10 for controlling the working of the air conditioner 10.

The function state information is information on the current state of each function for controlling the working of the air conditioner 10.

The air conditioner 10 may be a separate-type air conditioner including an indoor unit disposed indoors and an outdoor unit disposed outdoors, or may be an integrated-type air conditioner.

The operation terminal 20 is a communication device capable of communicating with the air conditioner 10 and the server 30. The operation terminal 20 can transmit various types of information including control instruction information for controlling the working of the air conditioner 10 to the air conditioner 10 via the Internet 40. In addition, the operation terminal 20 is connected to the Internet 40, and can receive information such as the working state information and the model information of the air conditioner 10 from the air conditioner 10 via the server 30. Note that the operation terminal 20 may be connected to the Internet 40 to directly receive information such as the working state information and the model information of the air conditioner 10 from the air conditioner 10.

The operation terminal 20 is connected to the Internet 40 and can transmit and receive information to and from the server 30. As a result, the operation terminal 20 can acquire, from the server 30 via the Internet 40, various types of information such as an inference result in an inference unit 352 to be described later.

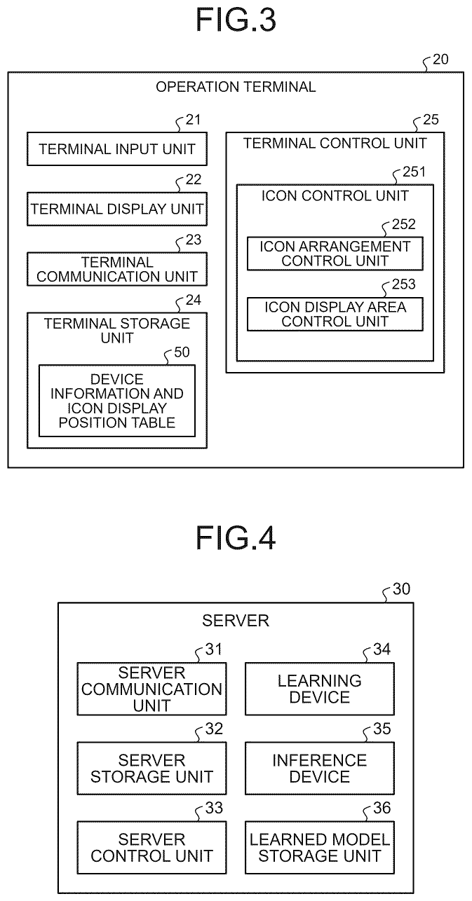

FIG. 3 is a block diagram illustrating a configuration of the operation terminal 20 in the air conditioning system 1 according to the first embodiment. The operation terminal 20 transmits various types of information such as control instruction information for controlling the working of the air conditioner 10 to the air conditioner 10 based on an operation on the operation terminal 20 by the user, and remotely operates the working of the air conditioner 10. That is, the operation terminal 20 transmits various types of information, such as control instruction information for controlling the working of the air conditioner 10, input from the user to the operation terminal 20, to the air conditioner 10 to control the working of the air conditioner 10. As the operation terminal 20, for example, a portable operation terminal that can be carried by a user, such as a smartphone, can be used.

The operation terminal 20 includes a terminal input unit 21, a terminal display unit 22, a terminal communication unit 23, a terminal storage unit 24, and a terminal control unit 25. These components of the operation terminal 20 can exchange information with each other.

The terminal input unit 21 is an operation receiving unit that receives a user operation, that is, a setting operation from the user. The setting operation from the user includes an operation for controlling the operation terminal 20 and a setting operation for controlling the working of the air conditioner 10. The terminal input unit 21 receives an input of a user operation and transmits information corresponding to the user operation to the terminal control unit 25. The terminal input unit 21 includes an input device such as a keyboard, a mouse, and a touch panel display having a touch panel function, and an operation on the operation terminal 20 is performed by the user. In the first embodiment, the terminal input unit 21 includes a touch panel display.

The terminal display unit 22 is a display unit that displays various types of information inside the operation terminal 20. The terminal display unit 22 displays an operation screen on which a setting operation for controlling the working of the air conditioner 10 is performed, and displays information for controlling the working of the air conditioner 10. That is, the terminal display unit 22 displays an operation screen for selecting a setting operation for controlling the working of the air conditioner 10. The operation screen can be rephrased as a control screen for controlling the working of the air conditioner 10. The information for controlling the working of the air conditioner 10 is, for example, working state information of the air conditioner 10.

In the first embodiment, the terminal display unit 22 includes a touch panel display. The touch panel display of the terminal display unit 22 can perform general operations on the touch panel display, such as a touch operation of touching the screen with a finger, a tap operation of tapping the screen once with a finger, a double tap operation of tapping the screen twice with a finger, and a drag operation of moving a place such as an icon to a desired position with a finger.

In addition, the terminal display unit 22 constituted by the touch panel display operably displays an operation icon. The operation icon is an icon corresponding to a function capable of controlling the working of the air conditioner 10 by the operation terminal 20. Therefore, the operation icon can be rephrased as an icon that specifies a function capable of performing control on the control target device by the operation terminal 20. The operation icons individually correspond to a plurality of functions of the air conditioner 10 in association with control instruction information indicating execution of the functions. In addition, the operation icon can be rephrased as an icon that specifies a function capable of performing control on the home appliance by the operation terminal 20.

The terminal communication unit 23 is connected to the Internet 40 and communicates with the air conditioner 10. The terminal communication unit 23 is connected to the Internet 40 and communicates with the server 30. The terminal communication unit 23 transmits various types of information transmitted from the air conditioner 10 and the server 30 to the terminal control unit 25. The terminal communication unit 23 transmits the control instruction information of the air conditioner 10 transmitted from the terminal control unit 25 to the air conditioner 10.

The terminal storage unit 24 is a storage unit that stores various types of information in the operation terminal 20. The terminal storage unit 24 stores various types of information transmitted from the air conditioner 10 and the server 30. The terminal storage unit 24 stores a device information and icon display position table 50 to be described later. Hereinafter, the device information and icon display position table 50 may be referred to as a table 50.

The operation terminal 20 includes air conditioning control application software for the operation terminal 20, which is application software for executing a device control function for controlling the working of the air conditioner 10. Specifically, the device control function is a function used in the operation terminal 20 to set the working conditions of the air conditioner 10 and transmit the working conditions to the air conditioner 10. The air conditioning control application software is stored in the terminal storage unit 24. The air conditioning control application software for the operation terminal 20 can be rephrased as home appliance control application software for executing a device control function which is a function used to set the working conditions of a home appliance and transmit the working conditions to the home appliance. Hereinafter, the air conditioning control application software may be simply referred to as an application.

The terminal control unit 25 is a control unit that controls the entire processing of the operation terminal 20. The terminal control unit 25 stores various types of information transmitted from the terminal communication unit 23 in the terminal storage unit 24. Furthermore, the terminal control unit 25 causes the terminal display unit 22 to display various types of information transmitted from the terminal communication unit 23.

The terminal control unit 25 executes the application stored in the terminal storage unit 24 to display information for controlling the working of the air conditioner 10 on the touch panel display which is the terminal display unit 22, and allows the user to operate the information. Specifically, the terminal control unit 25 executes the application stored in the terminal storage unit 24 to display an operation screen showing an operation icon indicating a function for controlling the working of the air conditioner 10 on the touch panel display which is the terminal display unit 22, and allows the user to operate the operation screen.

The terminal control unit 25 connects to a website of the manufacturer or the like of the air conditioner 10 via the terminal communication unit 23, and performs control to download an application for controlling the working of the air conditioner 10. The terminal control unit 25 stores the downloaded application in the terminal storage unit 24.

When a normal operation that is an operation for controlling the working of the air conditioner 10 is performed on the touch panel display, the terminal control unit 25 recognizes the operation content based on the information corresponding to the user operation transmitted from the terminal input unit 21. Then, the terminal control unit 25 generates control instruction information corresponding to the operation content, and transmits the control instruction information to the air conditioner 10 via the terminal communication unit 23. The air conditioner 10 receives the control instruction information transmitted from the terminal control unit 25, and the air conditioning control unit 14 controls the working of the air conditioner 10 based on the control instruction information.

In addition, the terminal control unit 25 includes an icon control unit 251. The icon control unit 251 is a control unit that controls display of operation icons on the terminal display unit 22. The icon control unit 251 includes an icon arrangement control unit 252 and an icon display area control unit 253. The icon arrangement control unit 252 is a control unit that controls the arrangement of the operation icons on the terminal display unit 22, that is, the display positions of operation icons on the terminal display unit 22 to control the display of the operation icons.

In addition, when an automatic rearrangement function of display of operation icons is implemented as described later, the terminal control unit 25 performs control to display a plurality of operation icons in an icon display area 221 of the terminal display unit 22 in order based on the inference result in the server 30. That is, the icon arrangement control unit 252 acquires the arrangement of the operation icons on the terminal display unit 22, that is, the information of the display positions of the operation icons on the terminal display unit 22 from the server 30, and performs control to display the plurality of operation icons in the icon display area 221 of the terminal display unit 22 in the order based on the information.

The icon display area control unit 253 is a control unit that controls the display area of the operation icons on the terminal display unit 22.

FIG. 4 is a block diagram illustrating a configuration of the server 30 in the air conditioning system 1 according to the first embodiment. To the server 30, working state information and model information of the air conditioner 10 are transmitted from the air conditioner 10 communicably connected via the Internet 40. That is, the server 30 can acquire the working state information of the air conditioner 10 from the air conditioner 10 via the Internet 40. As a result, the server 30 shares the working state information of the air conditioner 10 with the air conditioner 10. Then, the server 30 can transmit the working state information of the air conditioner 10 acquired from the air conditioner 10 to the operation terminal 20 via the Internet 40. As the server 30, a cloud server or a physical server can be used.

The server 30 can infer the operation frequency of each function of the plurality of functions of the air conditioner 10 based on the installation information of the air conditioner 10 including information regarding the environment of the location of the air conditioner 10 and information regarding the status of use of the air conditioner 10, and determine the display positions of the plurality of operation icons on the terminal display unit 22 of the operation terminal 20 based on the inferred operation frequency of each function.

The server 30 includes a server communication unit 31, a server storage unit 32, a server control unit 33, a learning device 34, an inference device 35, and a learned model storage unit 36. These components of the server 30 can exchange information with each other.

The server communication unit 31 is connected to the Internet 40 and communicates with the air conditioner 10. The server communication unit 31 is connected to the Internet 40 and communicates with the operation terminal 20.

The server storage unit 32 stores various types of information acquired from the air conditioner 10 and the operation terminal 20. The information stored in the Server storage unit 32 includes information such as information on the operation frequency of each function in the operation terminal 20 for a plurality of functions of the air conditioner 10, which is acquired from the air conditioner 10, model information of the air conditioner 10, installation information of the air conditioner 10, and working state information of the air conditioner 10. In addition, the information stored in the server storage unit 32 includes information on the display positions of operation icons on the terminal display unit 22 acquired from the operation terminal 20, and information on the display positions of operation icons inferred and determined by the server control unit 33. Therefore, the information stored in the server storage unit 32 includes learning data to be described later. Details of each information will be described later.

In addition, the server storage unit 32 stores a control program used for controlling the server 30. Among the various types of information stored in the server storage unit 32, information necessary for processing in the learning device 34 is transmitted to the learning device 34.

The server control unit 33 controls the entire processing of the server 30. In addition, the server control unit 33 performs control to acquire various types of information from the air conditioner 10, such as information on the operation frequency of each function of the air conditioner 10, model information of the air conditioner 10, installation information of the air conditioner 10, and working state information of the air conditioner 10, and store the acquired information in the server storage unit 32. In addition, the server control unit 33 performs control to transmit, to the operation terminal 20 via the Internet 40, information such as working state information of the air conditioner 10 and information on the display positions of operation icons of the operation terminal 20 that controls the air conditioner 10 inferred with a method to be described later.

The learning device 34 learns the tendency of the operation frequency of each function in the operation terminal 20 for the plurality of functions of the air conditioner 10 based on the learning data. The learning device 34 learns the tendency of the operation frequency of each function in the operation terminal 20 for the plurality of functions of the air conditioner 10 based on the learning data for the plurality of users input to the learning device 34. As a result, the learning device 34 can learn the tendency of the operation frequency of each function in the operation terminal 20 for the plurality of functions of the air conditioner 10 by consideration of the learning data for the plurality of users.

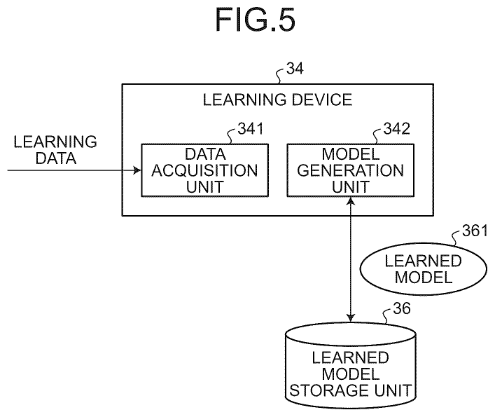

FIG. 5 is a diagram illustrating a configuration of the learning device 34 according to the first embodiment. The learning device 34 includes a data acquisition unit 341 and a model generation unit 342. The data acquisition unit 341 is a first data acquisition unit in the air conditioning system 1. In addition, the learned model storage unit 36 is provided outside the learning device 34. Note that although the learned model storage unit 36 is provided outside the learning device 34 in FIGS. 4 and 5, the learned model storage unit 36 may be provided inside the learning device 34 or in the server storage unit 32.

The data acquisition unit 341 acquires, as learning data, information on the operation frequency of each of a plurality of functions of the air conditioner 10 in the operation terminal 20, model information of the air conditioner 10, and installation information of the air conditioner 10. Here, the learning data is data in which information on the operation frequency of each function in the operation terminal 20 for a plurality of functions of the air conditioner 10, model information of the air conditioner 10, and installation information of the air conditioner 10 are associated with each other. The data acquisition unit 341 acquires the learning data from the server storage unit 32.

The information on the operation frequency of each function in the operation terminal 20 for the plurality of functions of the air conditioner 10 is information indicating the frequency at which each function of the air conditioner 10 in a predetermined period is operated in the operation terminal 20. That is, the information on the operation frequency of each function in the operation terminal 20 for the plurality of functions of the air conditioner 10 can be rephrased as information on the number of operations indicating the number of times each function of the air conditioner 10 has been operated in the predetermined period or information on the number of uses indicating the number of times each function of the air conditioner 10 has been used in the predetermined period. The information on the operation frequency of each function in the operation terminal 20 for the plurality of functions of the air conditioner 10 can be rephrased as information on the use frequency indicating the frequency of use of each function of the air conditioner 10 in the predetermined period. Hereinafter, the operation frequency of each function in the operation terminal 20 for the plurality of functions of the air conditioner 10 may be referred to as the operation frequency of the function.

The model information of the air conditioner 10 is information indicating the model of the air conditioner 10. The model information of the air conditioner 10 can be said to be information indicating the model of the home appliance.

The installation information of the air conditioner 10 is information including information on the environment of the location of the air conditioner 10 and information on the status of use of the air conditioner 10. The information on the environment of the location of the air conditioner 10 can be said to be information on the environment of the location of the home appliance. The information on the status of use of the air conditioner 10 can be said to be information on the status 4 use of the home appliance. The installation information of the air conditioner 10 can be said to be installation information of the home appliance.

The information on the environment of the location of the air conditioner 10 is exemplified by weather information, and includes the average precipitation of the location of the air conditioner 10 in a predetermined period and the average microparticulate matter concentration of the location of the air conditioner 10 in a predetermined period. The microparticulate matter is also called particulate matter (PM) 2.5.

A method for acquiring the information on the average precipitation at the location of the air conditioner 10 in the predetermined period and the information on the average PM 2.5 concentration at the location of the air conditioner 10 in the predetermined period is not particularly limited. For example, in the air conditioner 10, the information on the average precipitation at the location of the air conditioner 10 and the information on the average PM 2.5 concentration at the location of the air conditioner 10 are acquired from, for example, a weather information site via the Internet 40 and the air conditioning communication unit 13, and input to the air conditioning control unit 14. The air conditioning control unit 14 stores the acquired information on the average precipitation at the location of the air conditioner 10 and the acquired information on the average PM 2.5 concentration at the location of the air conditioner 10 in the air conditioning storage unit 12. In addition, the air conditioning control unit 14 transmits the information on the average precipitation at the location of the air conditioner 10 and the information on the average PM 2.5 concentration at the location of the air conditioner 10 stored in the air conditioning storage unit 12 to the server control unit 33 of the server 30 via the air conditioning communication unit 13.

The information on the status of use of the air conditioner 10 includes the accumulated amount of power of the air conditioner 10 in a predetermined period, the accumulated operating time of the air conditioner 10 in a predetermined period, the average value of indoor temperatures obtained by averaging, over a certain period, indoor temperatures in a predetermined period acquired from the air conditioner 10, and the average value of outdoor temperatures obtained by averaging, over a certain period, outdoor temperatures in a predetermined period acquired from the air conditioner 10.

A method for acquiring information on the accumulated amount of power of the air conditioner 10 in the predetermined period is not particularly limited. For example, in the air conditioner 10, information on the accumulated amount of power of the air conditioner 10 is acquired by the function of the air conditioning control unit 14. The air conditioning control unit 14 has a power amount summing function of, for example, counting and summing the power consumption of the air conditioner 10 to acquire information on the accumulated amount of power of the air conditioner 10. The air conditioning control unit 14 stores the acquired information on the accumulated amount of power of the air conditioner 10 in the air conditioning storage unit 12. The air conditioning control unit 14 transmits the information on the accumulated amount of power of the air conditioner 10 stored in the air conditioning storage unit 12 to the server control unit 33 of the server 30 via the air conditioning communication unit 13.

A method for acquiring the information on the accumulated operating time of the air conditioner 10 in the predetermined period is not particularly limited. For example, in the air conditioner 10, the information on the accumulated operating time of the air conditioner 10 is acquired by the function of the air conditioning control unit 14. The air conditioning control unit 14 has, for example, an operating time summing function of counting and summing the operating time of the air conditioner 10 to acquire information on the accumulated operating time of the air conditioner 10. The air conditioning control unit 14 stores the acquired information on the accumulated operating time of the air conditioner 10 in the air conditioning storage unit 12. The air conditioning control unit 14 transmits the information on the accumulated operating time of the air conditioner 10 stored in the air conditioning storage unit 12 to the server control unit 33 of the server 30 via the air conditioning communication unit 13.

In the air conditioner 10, the indoor temperature is measured at a predetermined cycle by an indoor temperature sensor included in the air conditioning unit 11, and is transmitted to the air conditioning control unit 14. The air conditioning control unit 14 stores the acquired information on the indoor temperature in the air conditioning storage unit 12. In addition, the air conditioning control unit 14 transmits the information on the indoor temperature stored in the air conditioning storage unit 12 to the server control unit 33 of the server 30 via the air conditioning communication unit 13.

In the air conditioner 10, the outdoor temperature is measured at a predetermined cycle by an outdoor temperature sensor included in the air conditioning unit 11, and is transmitted to the air conditioning control unit 14. The air conditioning control unit 14 stores the acquired outdoor temperature information in the air conditioning storage unit 12. In addition, the air conditioning control unit 14 transmits the information on the outdoor temperature stored in the air conditioning storage unit 12 to the server control unit 33 of the server 30 via the air conditioning communication unit 13.

Note that the predetermined period may be a specific period from the present to the past, or may be a period from the first start of control of the air conditioner 10 by the operation terminal 20 to the present, and is stored in the air conditioning storage unit 12 of the air conditioner 10. The predetermined period can be set to any period by the user from the operation terminal 20.

The information on the display positions of operation icons on the terminal display unit 22 is information on the arrangement of the operation icons on the terminal display unit 22. When displaying a plurality of operation icons on the terminal display unit 22, the terminal control unit 25 of the operation terminal 20 stores information on the display positions of the operation icons in the terminal storage unit 24 of the operation terminal 20. In addition, the terminal control unit 25 of the operation terminal 20 transmits information on the display positions of the operation icons stored in the terminal storage unit 24 to the server control unit 33 of the server 30 via the terminal communication unit 23. The terminal control unit 25 transmits the information on the display positions of the operation icons to the server control unit 33 of the server 30 via the terminal communication unit 23 in association with information on the time when the plurality of operation icons are displayed on the terminal display unit 22 or information on the time when information on the display positions of the operation icons is transmitted.

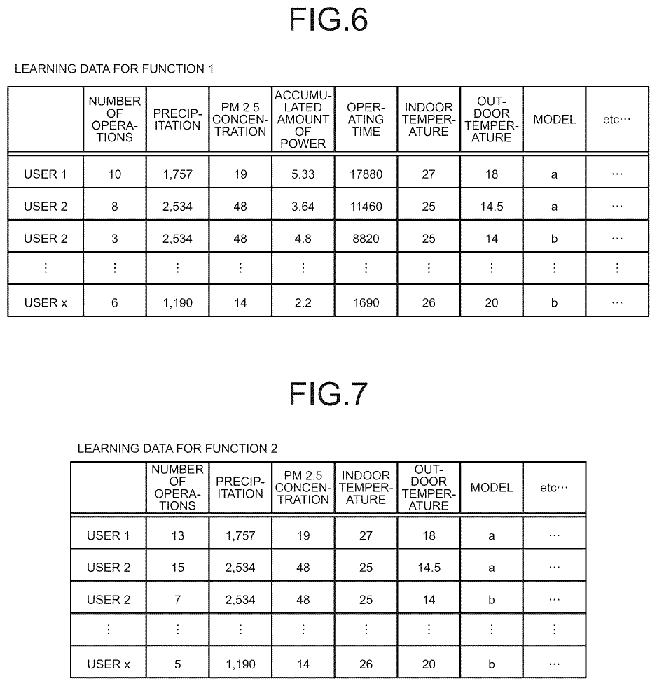

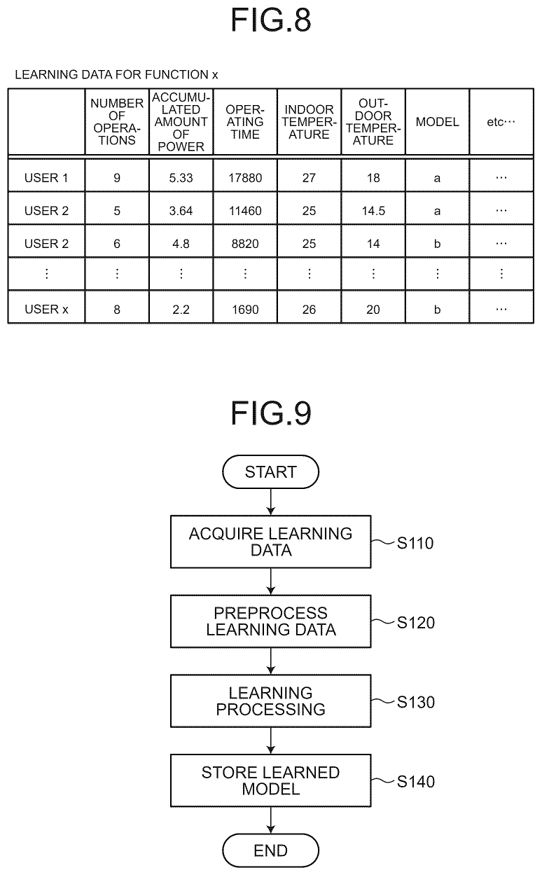

FIG. 6 is a diagram illustrating an example of learning data used when the learning device 34 according to the first embodiment learns the operation frequency of the function of the air conditioner 10 for function 1 of the air conditioner 10. FIG. 7 is a diagram illustrating an example of learning data used when the learning device 34 according to the first embodiment learns the operation frequency of the function of the air conditioner 10 for function 2 of the air conditioner 10. FIG. 8 is a diagram illustrating an example of learning data used when the learning device 34 according to the first embodiment learns the operation frequency of the function of the air conditioner 10 for function x of the air conditioner 10.

In FIGS. 6 to 8, the “number of operations” indicates the total number of operations for the functions of the air conditioner 10, which is information on the operation frequency of the functions of the air conditioner 10 in a predetermined period. Regarding the “number of operations”, the number of operations, which is the number of times a user has performed an operation to select a function capable of controlling the control target device by the operation terminal 20 on the operation screen of the operation terminal 20, is managed. That is, the number of operations is the number of times an operation icon is operated in a predetermined period for a certain function on the operation screen. The number of operations can be rephrased as the number of times control instruction information associated with the operation icon is transmitted from the operation terminal 20 to the air conditioner 10 by operating the operation icon.

In FIGS. 6 and 7, “precipitation” indicates the average precipitation at the location of the air conditioner 10 in a predetermined period. In FIGS. 6 and 7, “PM 2.5 concentration” indicates the average PM 2.5 concentration at the location of the air conditioner 10 in a predetermined period. In FIGS. 6 and 8, “accumulated amount of power” indicates the accumulated amount of power of the air conditioner 10 in a predetermined period. In FIGS. 6 and 8, “operating time” indicates the accumulated operating time of the air conditioner 10 in a predetermined period. In FIGS. 6 to 8, “indoor temperature” indicates the average value of indoor temperatures in a predetermined period. In FIGS. 6 to 8, “outdoor temperature” indicates the average value of outdoor temperatures in a predetermined period. In FIGS. 6 to 8, “model” indicates the model of the air conditioner 10.

The predetermined period in the above learning data may be a specific period from the present to the past, or may be a period from the first start of control of the air conditioner 10 by the operation terminal 20 to the present, and is stored in the air conditioning storage unit 12 of the air conditioner 10. The predetermined period can be set to any period by the user on the operation terminal 20.

When the learning device 34 learns the operation frequency of a function of the air conditioner 10 for the function of the air conditioner 10, the learning device 34 preprocesses the learning data acquired by the data acquisition unit 341. In the preprocessing of the learning data, the learning data is classified by model based on the model information of the air conditioner 10. The model generation unit 342 classifies the learning data acquired from the data acquisition unit 341 by model based on the model information of the air conditioner 10. As a result, it is possible to perform learning using information that matches the specification of the function of the air conditioner 10.

In addition, the learning device 34 learns the tendency of the operation frequency of each function with respect to the plurality of functions of the air conditioner 10. Therefore, in the preprocessing of the learning data, the learning data acquired from the data acquisition unit 341 is selected for each function to be learned based on the characteristic of the function to be learned such that only the learning data related to the characteristic of the function to be learned among the learning data acquired from the data acquisition unit 341 is utilized for learning. That is, the model generation unit 342 selects information for each function to be learned based on the characteristic of the function from among a plurality of types of information acquired as learning data such that only the learning data related to the function of the air conditioner 10 to be learned can be utilized for learning. The model generation unit 342 stores in advance relationship information indicating a correspondence relationship between the characteristic of the function to be learned and an item of learning data having a relationship with the characteristic of the function to be learned. The model generation unit 342 selects information for each function to be learned based on the characteristic of the function from among a plurality of types of information acquired as learning data based on the relationship information.

As described above, the processing of classifying the learning data acquired from the data acquisition unit 341 by model based on the model information of the air conditioner 10, and the processing of selecting the learning data related to the characteristic of the function to be learned for each function to be learned based on the characteristic of the function from among the plurality of types of learning data acquired from the data acquisition unit 341 are referred to as formatting of the learning data. In addition, the formatted learning data is referred to as post-format learning data. The formatting of the learning data is performed by the model generation unit 342.

For example, in a case where the learning device 34 learns the operation frequency of the function of the air conditioner 10 regarding the function of the air conditioner 10 that promotes indoor ventilation, information of “precipitation”, “PM 2.5 concentration”, “indoor temperature”, and “outdoor temperature”, which is information related to indoor ventilation, is selected and used as learning data. In addition, when the learning device 34 learns the operation frequency of the function of the air conditioner 10 with respect to the function of monitoring the electric bill of the air conditioner 10, which is a function of the air conditioner 10, information of the “accumulated amount of power” and the “operating time”, which is information related to the electric bill of the air conditioner 10, is selected and used as learning data.

For example, when the learning device 34 learns the operation frequency of the function of the air conditioner 10 for function 2 of the air conditioner 10, information of the “accumulated amount of power” and the “operating time” is not selected as the learning data, and information of the “accumulated amount of power” and the “operating time” is not illustrated in FIG. 7. Function 2 is, for example, a function of promoting ventilation in the room.

In addition, when the learning device 34 learns the operation frequency of the function of the air conditioner 10 with respect to function x of the air conditioner 10, information of the “precipitation” and the “PM 2.5 concentration” is not selected as the learning data, and information of the “precipitation” and the “PM 2.5 concentration” is not illustrated in FIG. 8. Function x is, for example, a function of monitoring the electric bill of the air conditioner 10.

The model generation unit 342 learns the operation frequency of the function of the air conditioner 10 based on the learning data generated based on the characteristic of the function of the air conditioner 10 output from the data acquisition unit 341. That is, the model generation unit 342 learns the operation frequency of the function of the air conditioner 10 based on the post-format learning data. The model generation unit 342 learns the tendency of the operation frequency of the function of the air conditioner 10 in order to infer the display positions of operation icons appropriate for the user, that is, to infer the display positions of the operation icons of a plurality of functions convenient for the user, from the tendency of the operation frequency of each function of the air conditioner 10 of the air conditioning system 1. Note that icon display positions on the terminal display unit 22 are determined based on the correspondence relationship among the operation frequency of the function, the model information of the air conditioner 10, and the restriction of the function.

The model generation unit 342 generates a learned model 361 for inferring the operation frequency of the function of the air conditioner 10 in the operation terminal 20 in order to infer the display positions of operation icons appropriate for the user based on the post-formatting learning data. That is, the model generation unit 342 generates the learned model 361 for inferring the display positions of operation icons preferable for the user from the tendency of the operation frequency of each function of the air conditioner 10 of the air conditioning system 1.

The learning algorithm that is used by the model generation unit 342 can be a known algorithm such as supervised learning, unsupervised learning, or reinforcement learning. As an example, a case where multiple regression analysis is applied will be described. For example, using the installation information of the air conditioner 10 as an explanatory variable, the model generation unit 342 calculates a regression equation representing the operation frequency of each function of the air conditioner 10 that is an objective variable as a learned model. Here, supervised learning refers to a model that provides data of inputs and results to the learning device to learn features in those learning data and infer results from inputs.

Next, a procedure for the process in which the learning device 34 learns will be described with reference to FIG. 9. FIG. 9 is a flowchart illustrating a procedure for learning processing by the learning device 34 according to the first embodiment.

In step S110, the data acquisition unit 341 acquires learning data. That is, the data acquisition unit 341 acquires information on the operation frequency of each function of the air conditioner 10, the model information of the air conditioner 10, and the installation information of the air conditioner 10 as learning data. The data acquisition unit 341 acquires the learning data from the server storage unit 32. The server control unit 33 acquires the above information from the air conditioner 10 and the operation terminal 20, and stores the acquired information in the server storage unit 32. The data acquisition unit 341 transmits the acquired learning data to the model generation unit 342. The model generation unit 342 receives the learning data transmitted from the data acquisition unit 341.

The data acquisition unit 341 may acquire information on the operation frequency of each function of the air conditioner 10, the model information of the air conditioner 10, and the installation information of the air conditioner 10 at the same timing or at different timings. That is, as long as the information on the operation frequency of each function of the air conditioner 10, the model information of the air conditioner 10, and the installation information of the air conditioner 10 are appropriately associated as the learning data, the data acquisition unit 341 may acquire each of the above information at any timing.

In step S120, formatting of the learning data, which is preprocessing of the learning data, is performed. In the preprocessing of the learning data, the learning data acquired from the data acquisition unit 341 is classified by model based on the model information of the air conditioner 10. That is, the model generation unit 342 classifies the learning data acquired from the data acquisition unit 341 by model based on the model information of the air conditioner 10.

In addition, in the preprocessing of the learning data, the learning data acquired from the data acquisition unit 341 is selected for each function to be learned. That is, the model generation unit 342 selects the learning data acquired from the data acquisition unit 341 for each function to be learned.

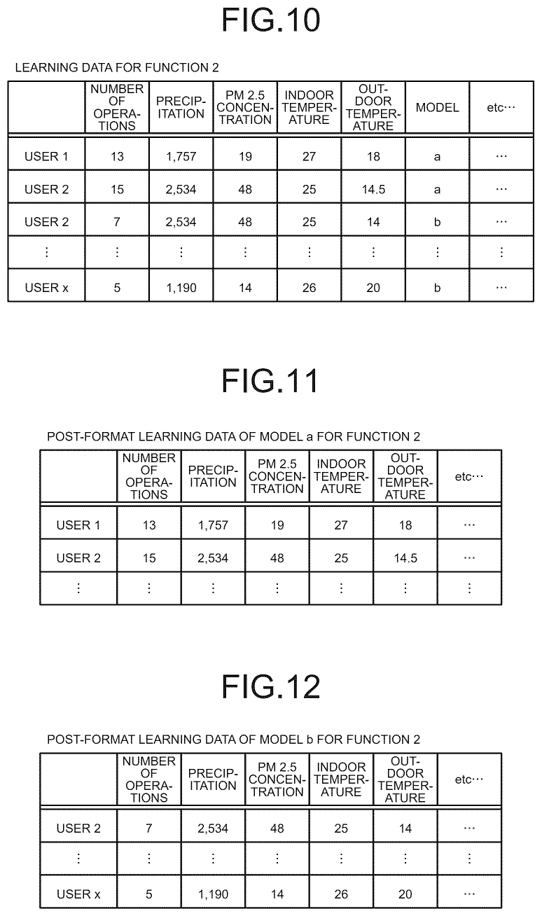

FIG. 10 is a diagram illustrating an example of learning data in the model generation unit 342 according to the first embodiment. FIG. 10 illustrates post-format learning data that is the learning data obtained by formatting the learning data acquired from the data acquisition unit 341 based on the information of “function 2” that is a function of the air conditioner 10. FIG. 11 is a diagram illustrating an example of post-format learning data which is the learning data into which the learning data illustrated in FIG. 10 is formatted. FIG. 11 illustrates post-format learning data that is the learning data into which the learning data illustrated in FIG. 10 is formatted based on the information of “model a” that is the model of the air conditioner 10 and “function 2” that is the function of the air conditioner 10. FIG. 12 is a diagram illustrating an example of post-format learning data which is the learning data into which the learning data illustrated in FIG. 10 is formatted. FIG. 12 illustrates post-format learning data that is the learning data into which the learning data illustrated in FIG. 10 is formatted based on the information of “model b” that is the model of the air conditioner 10 and “function 2” that is the function of the air conditioner 10.

In step S130, the model generation unit 342 executes learning processing according to the post-format learning data. The model generation unit 342 learns the tendency of the operation frequency for each function of the air conditioner 10 by so-called supervised learning according to the post-format learning data, for example, and generates the learned model 361.

In step S140, the learned model storage unit 36 stores the learned model 361. That is, the model generation unit 342 stores the generated learned model 361 in the learned model storage unit 36.

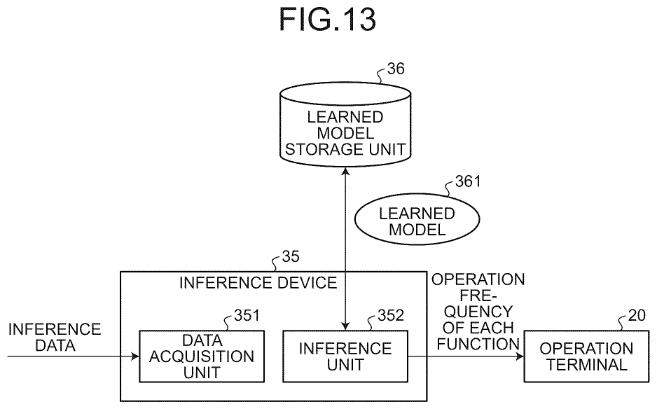

FIG. 13 is a diagram illustrating a configuration of the inference device 35 according to the first embodiment. The inference device 35 includes a data acquisition unit 351 and the inference unit 352. The data acquisition unit 351 is a second data acquisition unit in the air conditioning system 1. The inference unit 352 is connected to the learned model storage unit 36. The inference unit 352 outputs the operation frequency of each function of the air conditioner 10 using the learned model 361 obtained by the learning device 34.

The data acquisition unit 351 acquires model information of the air conditioner 10 and installation information of the air conditioner 10 as inference data. The inference data can be said to be user data related to a target user. The target user is a user who is a target for determining appropriate display positions of operation icons on the terminal display unit 22 of the operation terminal 20. The inference data is input to the data acquisition unit 351 from the outside of the server 30.

The inference unit 352 outputs the operation frequency of each function of the air conditioner 10 for the operation icons in the operation terminal 20 using the learned model 361. That is, by inputting the inference data acquired by the data acquisition unit 351 to the learned model 361, the inference unit 352 can infer and output the operation frequency of each function of the air conditioner 10 for the operation icons in the operation terminal 20 of the target user.

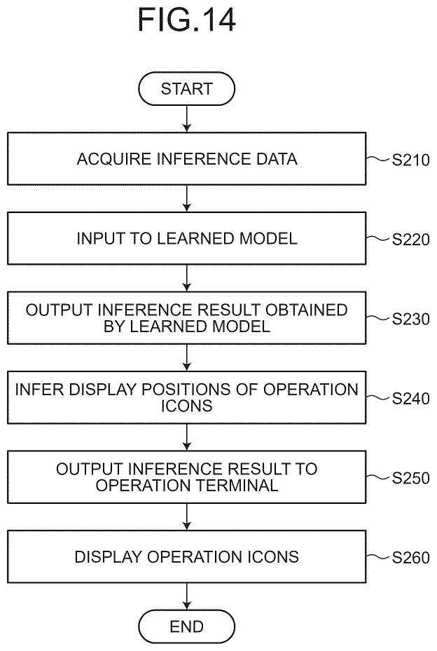

Next, processing in which the inference device 35 infers the operation frequency of each function of the air conditioner 10 will be described with reference to FIG. 14. FIG. 14 is a flowchart illustrating a procedure for inference processing by the inference device 35 according to the first embodiment.

In step S210, the data acquisition unit 351 acquires inference data. That is, the data acquisition unit 351 acquires model information of the air conditioner 10 and installation information of the air conditioner 10 as inference data.

In step S220, the inference unit 352 inputs the model information of the air conditioner 10 and the installation information of the air conditioner 10, which are the inference data acquired by the data acquisition unit 351, to the learned model 361 stored in the learned model storage unit 36, and obtains the operation frequency of each function of the air conditioner 10 corresponding to the input information as the inference result obtained by the learned model 361.

In step S230, the inference result obtained by the learned model 361 is output to the server control unit 33. Specifically, the inference unit 352 transmits the inference result obtained by the learned model 361 to the Server control unit 33.

The inference result obtained by the learned model 361 is information on the operation frequency of each function for a plurality of functions of the air conditioner 10 corresponding to the inference data acquired by the data acquisition unit 351.

In step S240, the display positions of the plurality of operation icons on the terminal display unit 22 of the operation terminal 20 are inferred. Specifically, the server control unit 33 infers display positions of a plurality of operation icons on the terminal display unit 22 of the operation terminal 20. That is, the server control unit 33 uses the information on the operation frequency of each function of the air conditioner 10 output from the inference unit 352 to infer the display positions of the plurality of operation icons on the terminal display unit 22 of the operation terminal 20. The server control unit 33 compares the information on the operation frequencies of the plurality of functions, determines the operation icon of a function having a higher operation frequency as an operation icon having a higher order of display positions, and infers display positions of the plurality of operation icons on the terminal display unit 22 of the operation terminal 20. That is, the server control unit 33 uses the inference result obtained by the learned model 361 to infer and determine the display positions of the plurality of operation icons on the terminal display unit 22 of the operation terminal 20. As a result, the server control unit 33 can determine the display positions of the operation icons of the plurality of functions convenient for the user on the terminal display unit 22 of the operation terminal 20 in an appropriate order convenient for the user.

In step S250, the inference result inferred using the inference result obtained by the learned model 361 is output to the operation terminal 20. Specifically, the server control unit 33 transmits, to the operation terminal 20, display position information that is information on the display positions of the plurality of operation icons on the terminal display unit 22 of the operation terminal 20, which is the inference result inferred using the information on the operation frequency of each function of the air conditioner 10 output from the inference unit 352.

In step S260, the operation terminal 20 displays the plurality of operation icons on the terminal display unit 22 of the operation terminal 20 at the display positions according to the display position information, that is, at the display positions according to the information of the display positions of the plurality of operation icons on the terminal display unit 22, which is the inference result in the server control unit 33.

As described above, since the inference unit 352 uses the learned model 361 that has learned the tendency of the operation frequency of each function of the air conditioner 10, the operation frequency of each function of the air conditioner 10 for the target user can be easily inferred. Then, the server control unit 33 can easily determine the display positions of the operation icons for displaying the operation icons of the plurality of functions convenient for the target user in an appropriate order convenient for the user based on the inference result in the inference unit 352 obtained by the learned model 361.

By applying the learning device 34 and the inference device 35 described above to the air conditioning system 1, the inference device 35 can infer the operation frequency of the functions of the plurality of air conditioners 10 including the functions convenient for the user, and the server control unit 33 can determine the display positions of the operation icons of the plurality of functions of the plurality of air conditioners 10 including the functions convenient for the user in an appropriate order convenient for the user and present the display positions to the user.

In the first embodiment, it has been described that the operation frequency of each function of the air conditioner 10 is output using the learned model 361 learned by the model generation unit 342 of the air conditioning system 1. However, the learned model 361 may be acquired from outside such as from another system, and the operation frequency of each function of the air conditioner 10 may be output based on the learned model 361.

In the first embodiment, the case where supervised learning is applied to the learning algorithm used by the model generation unit 342 has been described, but the present disclosure is not limited thereto. As the learning algorithm used by the model generation unit 342, reinforcement learning, unsupervised learning, semi-supervised learning, or the like can be applied instead of supervised learning.

As the learning algorithm for use in the model generation unit 342, it is also possible to use deep learning, which learns feature extraction directly. The model generation unit 342 may also execute machine learning according to another known method, e.g. a neural network, genetic programming, functional logic programming, a support vector machine, or the like.

The model generation unit 342 may learn the operation frequency of the operation icons of the functions of the air conditioner 10 in the input state using the learning data acquired from the plurality of air conditioning systems 1. Note that the model generation unit 342 may acquire learning data from a plurality of air conditioning systems 1 used in the same area, or may learn the operation frequency of the operation icons of the functions of the air conditioner 10 in the input state using learning data collected from a plurality of air conditioning systems 1 running independently in different areas. In addition, in the middle of learning, it is possible to add or remove an air conditioning system 1 from which learning data is collected. Furthermore, the learning device 34 that has learned the operation frequency of the operation icons of the functions of the air conditioner 10 in the input state for a certain air conditioning system 1 may be applied to another air conditioning system 1, and the operation frequency of the operation icons of the functions of the air conditioner 10 in the input state may be relearned and updated for that air conditioning system 1.

Furthermore, the learning device 34 and the inference device 35 may be, for example, devices separate from the server 30 and connected to the server 30 via a network such as the Internet.

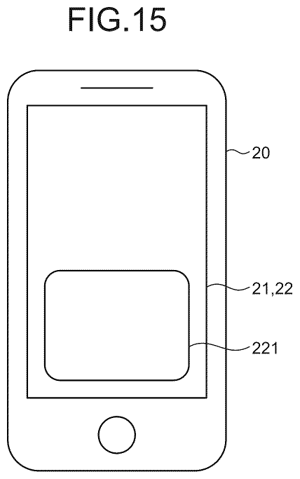

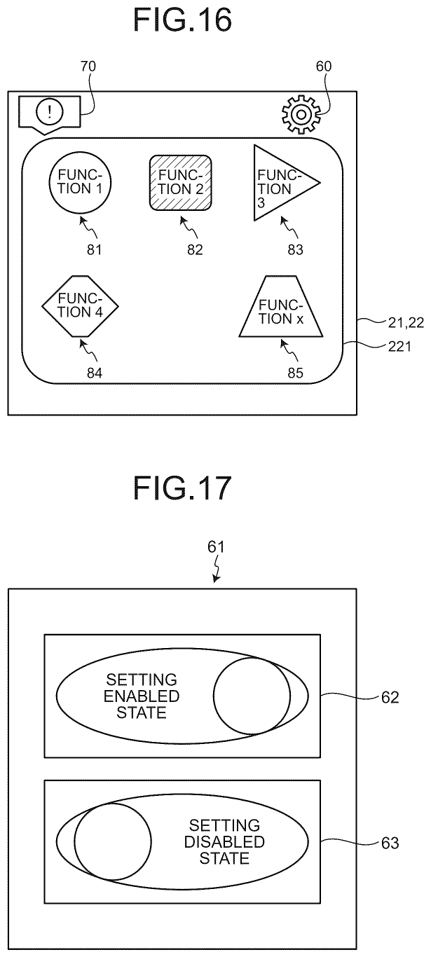

Next, the operation of the air conditioning system 1 will be described. FIG. 15 is a diagram illustrating the icon display area 221 of the operation screen displayed on the terminal display unit 22 of the operation terminal 20 according to the first embodiment. FIG. 16 is an enlarged diagram illustrating the icon display area 221 of the operation screen displayed on the terminal display unit 22 illustrated in FIG. 15. FIG. 17 is a diagram illustrating a function implementation setting screen 61 displayed on the terminal display unit 22 of the operation terminal 20 according to the first embodiment.

When the user remotely controls the air conditioner 10 using the operation terminal 20, the user operates the terminal input unit 21 of the operation terminal 20 to start the application. When the application is activated, as illustrated in FIG. 16, the terminal control unit 25 of the operation terminal 20 displays a notification icon 70, which is an icon of the automatic rearrangement function of display of operation icons, on the terminal display unit 22.

The automatic rearrangement function of display of operation icons is a function of automatically rearranging the display of the plurality of operation icons on the terminal display unit 22 of the operation terminal 20.

The notification icon 70 corresponds to the automatic rearrangement function of display of operation icons, and is a notification icon for notifying the user of the automatic rearrangement function of display of operation icons. Hereinafter, the “automatic rearrangement function of display of operation icons” may be referred to as an “automatic rearrangement function”.

The user can determine whether to set the automatic rearrangement function in advance. The server control unit 33 periodically determines whether to implement the automatic rearrangement function, and the determination as to whether to implement the automatic rearrangement function is transmitted to the operation terminal 20 via the server communication unit 31. By the user selecting the notification icon 70 displayed on the terminal display unit 22 using the terminal input unit 21, the arrangement order of the function icons in the icon display area 221 described later can be rearranged to update the arrangement order of the function icons. The user can select the notification icon 70 by touching the notification icon 70 displayed on the terminal display unit 22, for example.

By the user selecting a function setting icon 60 displayed on the terminal display unit 22 using the terminal input unit 21 as illustrated in FIG. 16, the display screen of the terminal display unit 22 transitions to the function implementation setting screen 61 as illustrated in FIG. 17. That is, when the function setting icon 60 displayed on the terminal display unit 22 is selected, the display screen of the terminal display unit 22 transitions to the function implementation setting screen 61.

The function setting icon 60 is an icon for transitioning to the function implementation setting screen 61. The function implementation setting screen 61 is a screen for the user to set whether to implement the automatic rearrangement function. On the function implementation setting screen 61, a function enable setting button 62 and a function disable setting button 63 are displayed.

The function enable setting button 62 is a setting button for enabling the automatic rearrangement function. The function disable setting button 63 is a setting button for disabling the automatic rearrangement function.

By the user selecting the function enable setting button 62 or the function disable setting button 63 on the function implementation setting screen 61, whether to enable the automatic rearrangement function is determined and set. That is, when the function enable setting button 62 is selected on the function implementation setting screen 61, the automatic rearrangement function is enabled in the server 30 and the operation terminal 20. When the function disable setting button 63 is selected on the function implementation setting screen 61, the automatic rearrangement function is disabled in the server 30 and the operation terminal 20.

When the user selects the function enable setting button 62 or the function disable setting button 63 on the function implementation setting screen 61, function setting information corresponding to the function enable setting button 62 or the function disable setting button 63 is transmitted from the terminal input unit 21 to the terminal control unit 25. Upon receiving the function setting information transmitted from the terminal input unit 21, the terminal control unit 25 transmits the function setting information to the server 30 via the terminal communication unit 23. The function setting information corresponding to the function enable setting button 62 is function enable setting information for enabling the automatic rearrangement function. The function setting information corresponding to the function disable setting button 63 is function disable setting information for disabling the automatic rearrangement function. Therefore, the function setting information is information for setting whether to implement the automatic rearrangement function.

The server communication unit 31 of the server 30 receives the function setting information transmitted from the operation terminal 20, and transmits the function setting information to the server control unit 33. Upon receiving the function setting information transmitted from the server communication unit 31, the server control unit 33 stores the function setting information in the server storage unit 32. If the function setting information has already been stored in the server storage unit 32, the server control unit 33 updates and stores the function setting information stored in the server storage unit 32. That is, the server control unit 33 overwrites the function setting information stored in the server storage unit 32 with the acquired latest information and stores the overwritten information. As a result, whether to implement the automatic rearrangement function is set in the server 30.

Then, based on the function setting information stored in the server storage unit 32, the server control unit 33 transmits display instruction information of the notification icon 70, which is information indicating that the notification icon 70 is to be displayed on the terminal display unit 22 of the operation terminal 20, to the terminal control unit 25 of the operation terminal 20.

When the function setting information stored in the server storage unit 32 is the function enable setting information, the server control unit 33 transmits display instruction information of the notification icon 70, which is information indicating that the notification icon 70 is to be displayed on the terminal display unit 22 of the operation terminal 20, to the terminal control unit 25 of the operation terminal 20. The display instruction information of the notification icon 70 is information on whether to display the notification icon 70. When receiving the display instruction information of the notification icon 70 from the server control unit 33, the terminal control unit 25 stores the display instruction information of the notification icon 70 in the terminal storage unit 24. If the information on whether to display the notification icon 70 has already been stored in the terminal storage unit 24, the terminal control unit 25 updates and stores the information on whether to display the notification icon 70 stored in the terminal storage unit 24. That is, the terminal control unit 25 overwrites the information on whether to display the notification icon 70 stored in the terminal storage unit 24 with the display instruction information that is the acquired latest information and stores the overwritten information. When the display instruction information of the notification icon 70 is stored in the terminal storage unit 24, the terminal control unit 25 causes the terminal display unit 22 of the operation terminal 20 to display the notification icon 70.

When the function setting information stored in the server storage unit 32 is the function disable setting information, the server control unit 33 transmits non-display instruction information of the notification icon 70, which is information indicating that the notification icon 70 is not to be displayed on the terminal display unit 22 of the operation terminal 20, to the terminal control unit 25 of the operation terminal 20. The non-display instruction information of the notification icon 70 is information on whether to display the notification icon 70. When receiving the non-display instruction information of the notification icon 70 from the server control unit 33, the terminal control unit 25 stores the non-display instruction information of the notification icon 70 in the terminal storage unit 24. If the information on whether to display the notification icon 70 has already been stored in the terminal storage unit 24, the terminal control unit 25 updates and stores the information on whether to display the notification icon 70 stored in the terminal storage unit 24. That is, the terminal control unit 25 overwrites the information on whether to display the notification icon 70 stored in the terminal storage unit 24 with the non-display instruction information that is the acquired latest information and stores the overwritten information. When the non-display instruction information of the notification icon 70 is stored in the terminal storage unit 24, the terminal control unit 25 does not cause the terminal display unit 22 of the operation terminal 20 to display the notification icon 70.

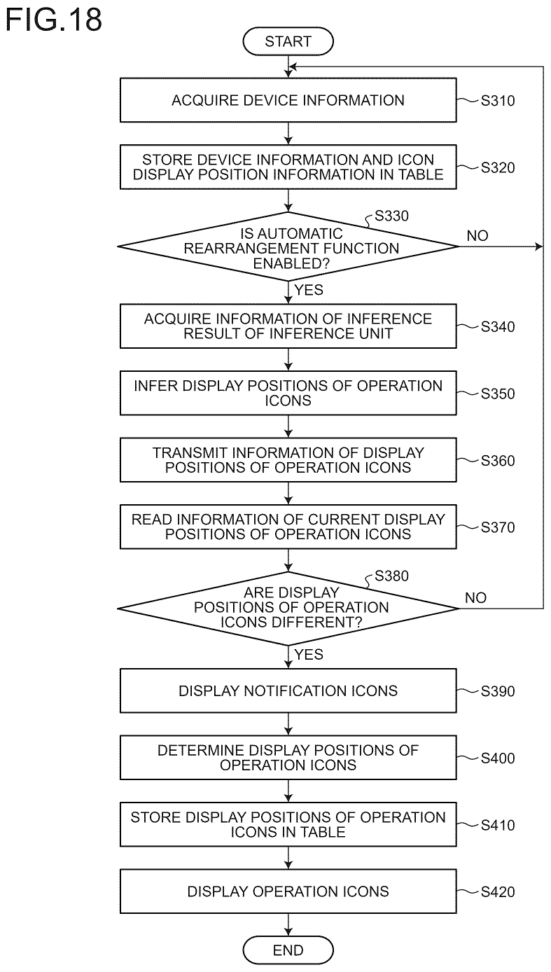

FIG. 18 is a flowchart illustrating a procedure of an operation of automatic rearrangement of display of operation icons in the operation terminal 20 of the air conditioning system 1 according to the first embodiment.

In step S310, the operation terminal 20 acquires device information of the air conditioner 10 to be subjected to working control by the operation terminal 20. Specifically, in the operation terminal 20, the icon arrangement control unit 252 of the icon control unit 251 in the terminal control unit 25 acquires, from the air conditioner 10, the device information of the air conditioner 10 to be subjected to working control by the operation terminal 20.

The icon arrangement control unit 252 transmits device information request information for requesting the device information of the air conditioner 10 to the air conditioning control unit 14 of the air conditioner 10 via the Internet 40. That is, the icon arrangement control unit 252 transmits the device information request information for requesting the device information of the air conditioner 10 to the terminal communication unit 23 of the operation terminal 20. Upon receiving the device information request information transmitted from the icon arrangement control unit 252, the terminal communication unit 23 transmits the device information request information to the air conditioning communication unit 13 of the air conditioner 10 via the Internet 40.

Upon receiving the device information request information transmitted from the terminal communication unit 23, the air conditioning communication unit 13 transmits the device information request information to the air conditioning control unit 14 of the air conditioner 10. Upon receiving the device information request information transmitted from the air conditioning communication unit 13, the air conditioning control unit 14 transmits device information including the name information of the function of the air conditioner 10 and the function state information of the air conditioner 10 to the air conditioning communication unit 13. The device information of the air conditioner 10 is stored in the air conditioning storage unit 12 of the air conditioner 10. The air conditioning control unit 14 acquires the device information from the air conditioning storage unit 12, and transmits the acquired device information to the air conditioning communication unit 13.

Upon receiving the device information transmitted from the air conditioning control unit 14, the air conditioning communication unit 13 transmits the device information to the terminal communication unit 23 of the operation terminal 20 via the Internet 40.

Upon receiving the device information transmitted from the air conditioning communication unit 13, the terminal communication unit 23 transmits the device information to the icon arrangement control unit 252 of the operation terminal 20. The icon arrangement control unit 252 receives the device information transmitted from the terminal communication unit 23. As a result, the device information of the air conditioner 10 is acquired by the icon arrangement control unit 252. Thereafter, the procedure proceeds to step S320.

In step S320, the device information acquired from the air conditioner 10 and information on the current display positions of operation icons are stored in the operation terminal 20. Specifically, the icon arrangement control unit 252 stores the device information acquired from the air conditioner 10 and the information on the current display positions of operation icons on the terminal display unit 22 of the operation terminal 20 in the device information and icon display position table 50 of the terminal storage unit 24 of the operation terminal 20. Information on the current display positions of operation icons on the terminal display unit 22 of the operation terminal 20 is stored in the terminal storage unit 24.

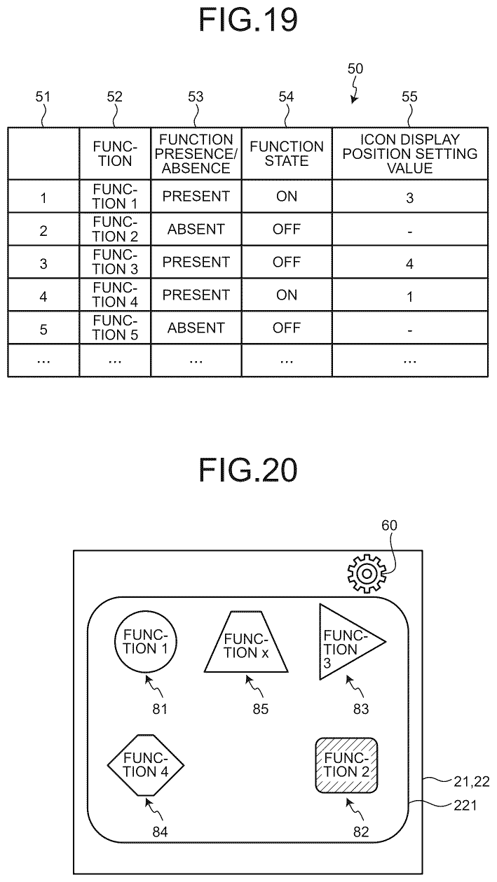

FIG. 19 is a diagram illustrating an example of the device information and icon display position table 50 stored in the terminal storage unit 24 of the operation terminal 20 according to the first embodiment.

The device information and icon display position table 50 is a table that stores the device information of the air conditioner 10 to be subjected to working control by the operation terminal 20 and the information of the current display positions of operation icons on the terminal display unit 22 of the operation terminal 20.

The device information and icon display position table 50 includes a management No. field 51, a function field 52, a function presence/absence field 53, a function state field 54, and an icon display position setting value field 55.

In the management No. field 51A, a management No., which is a management number in the device information and icon display position table 50, is set.

In the function field 52, the name of a function capable of controlling the control target device by the operation terminal 20 is set and managed. Specifically, the name of a function capable of controlling the working of the control target device by the device control function of the operation terminal 20 is set and managed in the function field 52. The names of the functions set in the function field 52 are not necessarily limited to the functions of the air conditioner 10 that is a control target device currently subjected to working control by the operation terminal 20. Therefore, as a function capable of controlling the working of the control target device by the device control function of the operation terminal 20, a function that is not included in the air conditioner 10 currently subjected to working control by the operation terminal 20 may be registered.

That is, the operation terminal 20 cannot control the working of only one type of air conditioner 10 as the control target device, but can individually control the working of a plurality of types of air conditioners 10 having different manufacturers and specifications as the control target devices. The operation terminal 20 downloads an application for controlling the working of the air conditioner 10 for each air conditioner 10 that is a control target device. Then, the operation terminal 20 can control the working of the air conditioner 10 for each air conditioner 10 as a control target device by executing an application corresponding to the air conditioner 10 as a control target device.

In the function presence/absence field 53, the presence or absence of a function included in a control target device currently subjected to working control by the operation terminal 20 is set and managed. In FIG. 19, the presence or absence of the function of the air conditioner 10 is set and managed. In FIG. 19, “present” in the function presence/absence field 53 indicates that the air conditioner 10 currently subjected to working control by the operation terminal 20 has the function of the operation terminal 20 capable of controlling the control target device. In FIG. 19, “No” in the function presence/absence field 53 indicates that the air conditioner 10 currently subjected to working control by the operation terminal 20 does not have the function of the operation terminal 20 capable of controlling the control target device. The function presence/absence field 53 is set based on a setting value included in the device information of the air conditioner 10 acquired from the air conditioner 10.

In the function state field 54, function state information that is information on the current state of a function capable of controlling the control target device by the operation terminal 20 is set and managed. That is, in the function state field 54, function state information indicating whether the function capable of controlling the control target device by the operation terminal 20 is in the running state or in the suspended state is managed. The function state field 54 is set based on a setting value included in the device information of the air conditioner 10 acquired from the air conditioner 10.

In the icon display position setting value field 55, an icon display position setting value, which is a setting value indicating the current display positions of operation icons on the terminal display unit 22, is set and managed. More specifically, the icon display position setting value is a setting value indicating the display positions of operation icons in the icon display area 221 of the current operation screen displayed on the terminal display unit 22.

Therefore, it can be said that the table 50 includes a list of functions capable of controlling the control target device in the operation terminal 20, a list of functions of the air conditioner 10 that is the current control target device for the operation terminal 20, and the current icon display position setting value.

The operation icons displayed on the terminal display unit 22 are movable to any display positions on the terminal display unit 22 by the user operating the touch panel display of the terminal display unit 22. That is, the user can rearrange the operation icons displayed on the terminal display unit 22 to any display positions by performing, on the touch panel display, an operation of rearranging the operation icons, which is an operation of an instruction to rearrange the operation icons displayed on the terminal display unit 22 to any display positions. The user can rearrange the operation icons to any display positions on the terminal display unit 22 by drag operation, for example. The rearrangement operation of the operation icons by the user can be rephrased as an icon display order change operation by the user, in which the user changes the display order, which is the order of the display positions of the operation icons in the icon display area 221.

Then, the icon arrangement control unit 252 determines the display positions of operation icons on the terminal display unit 22, changes the display order of the operation icons on the terminal display unit 22, and rearranges the operation icons on the terminal display unit 22 in the changed display order of the operation icons, in response to the rearrangement operation of the operation icons by the user, that is, the icon display order change operation by the user. When rearranging the operation icons on the terminal display unit 22, the icon arrangement control unit 252 sets icon display position setting values corresponding to the display positions at which the rearranged operation icons are displayed in the icon display position setting value field 55 and stores the icon display position setting values in the table 50. If the icon display position setting value has already been set in the icon display position setting value field 55, the icon display position setting value is updated. As a result, the icon display position setting values corresponding to the display positions of the operation icons rearranged by the user are automatically stored in the icon display position setting value field 55 based on the operation of rearranging the operation icons performed by the user on the operation terminal 20. Therefore, the latest icon display position setting value corresponding to the display position at which the operation icon is displayed is stored in the icon display position setting value field 55.

In addition, the operation icons displayed on the terminal display unit 22 can be rearranged by changing the display order of the operation icons on the terminal display unit 22 by the automatic rearrangement function of the icon arrangement control unit 252. By the user selecting the notification icon 70 using the terminal input unit 21, the icon arrangement control unit 252 rearranges the arrangement order of the operation icons in the icon display area 221 by the automatic rearrangement function, and updates the arrangement order of the operation icons. When rearranging the operation icons on the terminal display unit 22 with the automatic rearrangement function, the icon arrangement control unit 252 sets icon display position setting values corresponding to the display positions at which the rearranged operation icons are displayed in the icon display position setting value field 55 and stores the icon display position setting values in the table 50.

As described above, in the table 50 illustrated in FIG. 19, the setting values included in the device information acquired from the control target device are input to the function presence/absence field 53 and the function state field 54. In addition, in the table 50 illustrated in FIG. 19, in the icon display position setting value field 55, the icon display position setting value is input in association with the user's operation icon rearrangement operation, that is, the icon display order change operation. In the icon display position setting value field 55, the icon display position setting value is input in accordance with the implementation of the automatic rearrangement function of the operation terminal 20.

In the icon display area 221, the order of display positions at which operation icons are displayed is determined. In FIG. 16, the display position where the operation icon 81 of function 1 is displayed is the first display position. In FIG. 16, the display position where the operation icon 82 of function 2 is displayed is the second display position. In FIG. 16, the display position where the operation icon 83 of function 3 is displayed is the third display position. In FIG. 16, the display position where the operation icon 84 of function 4 is displayed is the fourth display position. In FIG. 16, the display position where the operation icon 85 of function 5 is displayed is the fifth display position.

In the operation icon 82 of function 2 illustrated in FIG. 16, the restriction of the function of controlling the air conditioner 10 is indicated by hatching. The restriction on the function of controlling the air conditioner 10 is a restriction that disables execution of the function. Specifically, whether to restrict the function of controlling the air conditioner 10 is set according to the information stored in the function state field 54 of the table 50. The user can set the restriction of the function of controlling the air conditioner 10 in the air conditioner 10 through the terminal input unit 21 of the operation terminal 20.

That is, each model of the air conditioner 10 has a function of restricting the control of the air conditioner 10 by the operation terminal 20 in the air conditioner 10. The restricted functions include, as shown in the function field 52 of the table 50, functions capable of controlling the control target device by the operation terminal 20 and that are not included in the air conditioner 10 currently subjected to working control by the operation terminal 20. The functions that can be restricted include a function of the control target device currently subjected to working control by the operation terminal 20, which is indicated as “present” in the function presence/absence field 53 of the table 50. In the table 50, the function indicated as “present” in the function presence/absence field 53 and indicated as “off” in the function state field 54 is restricted in the air conditioner 10.

Icons of restricted functions in the air conditioner 10 are grayed out, that is, deactivated, and inoperable. In FIG. 16, the icon of the function restricted in the air conditioner 10 is indicated by hatching. The operation icon thus deactivated has the lowest priority of the display position at which the operation icon is displayed in the icon display area 221.

That is, the user can perform, using the terminal input unit 21 of the operation terminal 20, a setting operation to enable a function of the air conditioner 10 currently subjected to working control by the operation terminal 20. The air conditioning control unit 14 enables the function in accordance with the setting operation by the user and stores the information in the air conditioning storage unit 12. In addition, the user can perform, using the terminal input unit 21 of the operation terminal 20, a setting operation to disable a function of the air conditioner 10 currently subjected to working control by the operation terminal 20. The air conditioning control unit 14 disables the function in accordance with the setting operation by the user and stores the information in the air conditioning storage unit 12. Information indicating whether to restrict the function of controlling the air conditioner 10 is stored as device information in the function state field 54 of the table 50 by the icon arrangement control unit 252. Thereafter, the procedure proceeds to step S330.

In step S330, it is determined whether the automatic rearrangement function is enabled. Specifically, the server control unit 33 of the server 30 determines whether the automatic rearrangement function is enabled in the server 30. When the function disable setting information is stored in the server storage unit 32, the Server control unit 33 determines that the automatic rearrangement function is disabled. When the function enable setting information is stored in the server storage unit 32, the server control unit 33 determines that the automatic rearrangement function is enabled.

Determining that the automatic rearrangement function is disabled corresponds to No in step S330, and the procedure returns to step S310. Determining that the automatic rearrangement function is enabled corresponds to Yes in step S330, and the procedure returns to step S340.

In step S340, the information of the inference result of the inference unit 352 is acquired. Specifically, the server control unit 33 acquires, from the inference unit 352, information on the operation frequency of each function with respect to the plurality of functions of the air conditioner 10 in the operation terminal 20, which is the inference result obtained in the inference unit 352 using the learned model 361. Thereafter, the procedure proceeds to step S350.

In step S350, the display positions of the plurality of operation icons on the terminal display unit 22 of the operation terminal 20 are inferred. Specifically, the server control unit 33 infers the display positions of the plurality of operation icons on the terminal display unit 22 of the operation terminal 20 by using the information on the operation frequency of each function in the operation terminal 20 for the plurality of functions of the air conditioner 10 acquired from the inference unit 352. That is, the server control unit 33 uses the inference result obtained by the learned model 361 to infer the display positions of the plurality of operation icons on the terminal display unit 22 of the operation terminal 20. As a result, the server control unit 33 can determine the display positions of the operation icons of the plurality of functions convenient for the user on the terminal display unit 22 of the operation terminal 20 in an appropriate order convenient for the user. Note that the server control unit 33 periodically performs inference processing of inferring display positions of a plurality of operation icons on the terminal display unit 22 of the operation terminal 20 at a predetermined cycle. Thereafter, the procedure proceeds to step S360.

In step S360, information on the display positions of operation icons is transmitted to the operation terminal 20. Specifically, the server control unit 33 transmits the display position information, that is, the information of the display positions of the plurality of operation icons on the terminal display unit 22 of the operation terminal 20, which is the inference result in the server control unit 33, to the terminal control unit 25 of the operation terminal 20. That is, when the automatic rearrangement function is enabled in the server 30, the server control unit 33 infers the display positions of the plurality of operation icons on the terminal display unit 22 of the operation terminal 20, and transmits the inferred information to the terminal control unit 25 of the operation terminal 20. The terminal control unit 25 receives the display position information, that is, the information of the display positions of the plurality of operation icons on the terminal display unit 22 of the operation terminal 20 transmitted from the server control unit 33. Thereafter, the procedure proceeds to step S370.

In step S370, information on the current display positions of operation icons is read from the table 50. Specifically, the icon arrangement control unit 252 of the terminal control unit 25 of the operation terminal 20 reads the icon display position setting value set in the icon display position setting value field 55 of the table 50 of the terminal storage unit 24 for each function of the air conditioner 10. Thereafter, the procedure proceeds to step S380.

In step S380, it is determined whether the current display positions of operation icons on the terminal display unit 22 of the operation terminal 20 are different from the display positions of operation icons received from the server control unit 33. Specifically, the icon arrangement control unit 252 of the terminal control unit 25 of the operation terminal 20 determines whether the current display positions of the plurality of operation icons indicated by the icon display position setting values read from the icon display position setting value field 55 of the table 50 of the terminal storage unit 24 are different from the display positions of the plurality of operation icons indicated by the display position information, that is, the display positions of the plurality of operation icons inferred by the server control unit 33.

When the current display positions of operation icons on the terminal display unit 22 of the operation terminal 20 are the same as the display positions of operation icons received from the server control unit 33, No is selected in step S380, and the procedure returns to step S310. When the current display positions of operation icons on the terminal display unit 22 of the operation terminal 20 are different from the display positions of operation icons received from the server control unit 33, Yes is selected in step S380, and the procedure proceeds to step S390.

In step S390, the notification icon 70, which is an icon of the automatic rearrangement function of display of operation icons, is displayed on the terminal display unit 22. Specifically, the terminal control unit 25 causes the terminal display unit 22 to display the notification icon 70.

In addition, when No in step S380 and the current display positions of operation icons on the terminal display unit 22 of the operation terminal 20 are the same as the display positions of operation icons received from the server control unit 33, the terminal control unit 25 determines that the display positions of the plurality of current operation icons are the display positions of the operation icons of the plurality of functions that are already convenient for the user, and does not display the notification icon 70 on the terminal display unit 22.

In step S400, the display positions of the operation icons on the terminal display unit 22 are determined. Specifically, when the user selects the notification icon 70 displayed on the terminal display unit 22, in the icon arrangement control unit 252 of the icon control unit 251 of the terminal control unit 25, the plurality of operation icon display positions on the terminal display unit 22 are determined to be the content of the display position information, that is, the content of the information on the display positions of the plurality of operation icons transmitted from the server control unit 33, which serves as a trigger for the next step. The user can select the notification icon 70 by touching the notification icon 70 displayed on the terminal display unit 22, for example. Thereafter, the procedure proceeds to step S410.

In step S410, the determined display positions of operation icons are stored in the table 50 by the terminal control unit 25. Specifically, the icon arrangement control unit 252 of the icon control unit 251 of the terminal control unit 25 updates the setting value in the icon display position setting value field 55 of the table 50 with the icon display position setting value indicated in the information on the display positions of the plurality of operation icons transmitted from the server control unit 33.

In step S420, an operation icon is displayed on the terminal display unit 22 of the operation terminal 20. Specifically, the icon arrangement control unit 252 displays a plurality of operation icons in the icon display area 221 of the terminal display unit 22 in the order based on the setting in the icon display position setting value field 55 of the table 50. In addition, the icon arrangement control unit 252 displays the state of the function of the air conditioner 10 in the icon display area 221 of the terminal display unit 22 based on the setting of the function state field 54 of the table 50. That is, the icon arrangement control unit 252 performs display in which operation icons corresponding to the functions in the suspended state are hatched.

That is, the icon arrangement control unit 252 of the terminal control unit 25 receives the display position information that is the information on the display positions of the plurality of operation icons on the terminal display unit 22 transmitted from the server 30, and when the current display positions of the plurality of operation icons on the terminal display unit 22 are different from the display positions of the plurality of operation icons indicated in the display position information, displays the plurality of operation icons on the terminal display unit 22 at the display positions of the plurality of operation icons indicated in the display position information.

FIG. 20 is a diagram indicating that the operation icons displayed in the icon display area 221 of the terminal display unit 22 have been automatically rearranged by the automatic rearrangement function of display of operation icons in the first embodiment. When the automatic rearrangement function is performed, for example, the display state of the terminal display unit 22 illustrated in FIG. 16 changes to the display state of the terminal display unit 22 illustrated in FIG. 20.

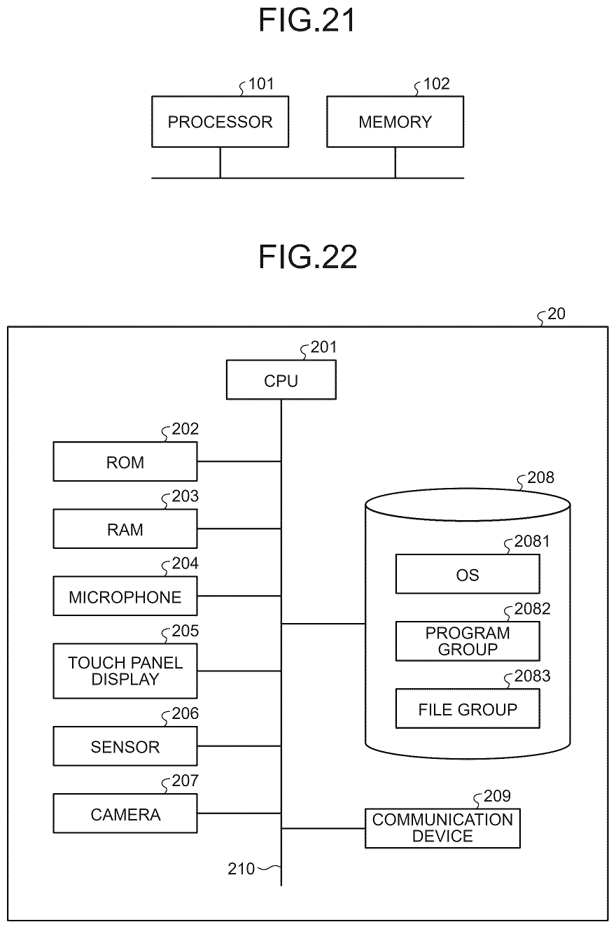

Each of the air conditioning control unit 14 of the air conditioner 10 and the server control unit 33 of the server 30 is implemented as, for example, processing circuitry having the hardware configuration illustrated in FIG. 21. FIG. 21 is a diagram illustrating an exemplary hardware configuration of the processing circuitry according to the first embodiment. When each of the air conditioning control unit 14 of the air conditioner 10 and the server control unit 33 of the server 30 is implemented by the processing circuitry illustrated in FIG. 21, the respective functions of the air conditioning control unit 14 of the air conditioner 10 and the server control unit 33 of the server 30 are implemented by a processor 101 executing a program stored in a memory 102. In addition, a plurality of processors and a plurality of memories may cooperate to implement the respective functions of the air conditioning control unit 14 of the air conditioner 10 and the server control unit 33 of the server 30. Some of the respective functions of the air conditioning control unit 14 of the air conditioner 10 and the server control unit 33 of the server 30 may be embodied as an electronic circuit, and the other functions may be implemented using the processor 101 and the memory 102.

On the other hand, FIG. 22 is a block diagram illustrating an exemplary hardware configuration for implementing the operation terminal 20 according to the first embodiment. The operation terminal 20 according to the first embodiment includes a central processing unit (CPU) 201, a read only memory (ROM) 202, a random access memory (RAM) 203, a microphone 204, a touch panel display 205, a sensor 206, a camera 207, a built-in memory 208, and a communication device 209. The CPU 201, the ROM 202, the RAM 203, the microphone 204, the touch panel display 205, the sensor 206, the camera 207, the built-in memory 208, and the communication device 209 are connected by a data bus 210.

The CPU 201 is an arithmetic device that executes an operating system (OS) 2081 for controlling the running of the operation terminal 20 and a program group 2082 that is various programs. The ROM 202 stores a program executed by the CPU 201 during the running of the operation terminal 20 in a nonvolatile manner. The RAM 203 is a work area used when the CPU 201 executes a program. The microphone 204 detects a sound and stores the detected sound in the built-in memory 208 as an electric signal. In addition, the built-in memory 208 stores various data used or acquired in the running of the operation terminal 20. The touch panel display 205 displays various types of information and receives various operations by the user. The sensor 206 is a sensor used to implement a function of the operation terminal 20, and is, for example, a sensor such as a global positioning system (GPS) sensor, an acceleration sensor, or an optical sensor. The camera 207 is an imaging device used to implement the functions of the operation terminal 20. The built-in memory 208 is a device that stores, in a nonvolatile manner, the OS 2081, the program group 2082, a file group 2083 that is various files for controlling the running of the operation terminal 20, and the like, and a hard disk drive (HDD), a solid state drive (SSD), and the like can be applied. The communication device 209 is a communication device for communicating with the air conditioner 10 and the server 30 which are external devices.

When the terminal control unit 25 of the operation terminal 20 is implemented by the hardware configuration illustrated in FIG. 22, the terminal control unit 25 is implemented by the CPU 201 executing a program of the program group 2082 stored in the built-in memory 208. In addition, a plurality of CPUs 201 and a plurality of built-in memories 208 may cooperate to implement the functions of the terminal control unit 25. Some of the functions of terminal control unit 25 may be embodied as an electronic circuit, and the other functions may be implemented using the CPU 201 and the built-in memory 208.

The terminal input unit 21 and the terminal display unit 22 are implemented by the touch panel display 205. The terminal communication unit 23 is implemented by the communication device 209. The terminal storage unit 24 is implemented by the ROM 202 and the built-in memory 208.

According to the air conditioning system 1 of the first embodiment described above, a home appliance control system is implemented that includes: a home appliance; the operation terminal 20 including a display unit that displays a plurality of operation icons individually corresponding to a plurality of functions of the home appliance in association with control instruction information indicating execution of the functions; and the server 30 that determines display positions of the plurality of operation icons on the display unit based on installation information of the home appliance including information regarding an environment of a location of the home appliance and information regarding a status use of the home appliance.

In addition, according to the operation terminal 20 of the first embodiment described above, an operation terminal is implemented that constitutes a home appliance control system including a home appliance, a server, and an operation terminal and remotely operating the home appliance, the operation terminal being configured to transmit control instruction information for controlling the home appliance to the home appliance, the operation terminal including: a display unit that displays a plurality of operation icons individually corresponding to a plurality of functions of the home appliance in association with control instruction information; and a terminal control unit that causes the display unit to display the plurality of operation icons, wherein the terminal control unit receives display position information transmitted from the server, the display position information being information on display positions of the plurality of operation icons on the display unit; and when current display positions of the plurality of operation icons on the display unit are different from display positions of the plurality of operation icons indicated in the display position information, causes the display unit to display the plurality of operation icons at the display positions of the plurality of operation icons indicated in the display position information.

In addition, according to the server 30 of the first embodiment described above, a server is implemented that constitutes a home appliance control system including: a home appliance; an operation terminal including a display unit that displays a plurality of operation icons individually corresponding to a plurality of functions of the home appliance in association with control instruction information indicating execution of the functions; and the server, the home appliance control system being configured to remotely operate the home appliance, the server including a server control unit that infers an operation frequency of each function with respect to the plurality of functions based on installation information of the home appliance including information regarding an environment of a location of the home appliance and information regarding a status of use of the home appliance, and determines display positions of the plurality of operation icons on the display unit based on the operation frequency of each function inferred.

As described above, the air conditioning system 1 according to the first embodiment can determine an appropriate display order of functions convenient for the user on the terminal display unit 22 of the operation terminal 20. That is, the inference device 35 of the server 30 analogizes the operation frequency of each function with respect to the plurality of functions of the air conditioner 10 based on the installation information of the air conditioner 10 including the information regarding the environment of the location of the air conditioner 10 and the information regarding the status of use of the air conditioner 10, which are the information collected by the air conditioning system 1. Then, the server control unit 33 of the server 30 determines the display positions of the operation icons of the plurality of functions on the terminal display unit 22 of the operation terminal 20 based on the analogized operation frequency of each function.

As a result, the server 30 can automatically determine the display positions of the operation icons of the plurality of functions convenient for the user on the terminal display unit 22 of the operation terminal 20 in an appropriate order convenient for the user. That is, the server 30 infers and determines the display priority of functions appropriate for the user from the viewpoint of convenience of the user, and thus, it is possible to promote the discovery of functions potentially useful for the user.

The operation terminal 20 that has acquired the information on the display positions of the operation icons determined by the server 30 automatically rearranges and displays the plurality of operation icons on the terminal display unit 22 according to the display positions of the operation icons determined by the server 30 when the notification icon 70 displayed on the terminal display unit 22 is selected in a case where the automatic rearrangement function of display of operation icons is enabled in the server 30 and the operation terminal 20.

As a result, the user can visually and easily understand the function of the air conditioner 10 that is convenient for the user and can be controlled from the operation terminal 20 by looking at the terminal display unit 22 of the operation terminal 20. Therefore, the user can comfortably use a plurality of functions, and operability of the operation terminal 20 by the user is improved. That is, when the user operates the operation terminal 20, the terminal display unit 22 of the operation terminal 20 shows the operation icons arranged in an appropriate order convenient for the user and in an order desired by the user, so that operability of the operation terminal 20 for the user to control the air conditioner 10 is improved.

In addition, the model generation unit 342 of the server 30 selects information for each function to be learned based on the characteristic of the function from among a plurality of types of information acquired as learning data such that only the learning data related to the function of the air conditioner 10 to be learned about the tendency of the operation frequency of each function in the operation terminal 20 for a plurality of functions of the air conditioner 10 can be utilized for learning. As a result, the server 30 can learn using information suitable for the properties of each function, and from the viewpoint of convenience of the user, it is possible to enhance the accuracy of inference of the display priority of functions appropriate for the user, and to further promote the discovery of functions potentially useful for the user.

In addition, the server 30 learns using, as learning data, the installation information of the air conditioner 10 including information regarding the environment of the location of the air conditioner 10 and information regarding the status of use of the air conditioner 10, and analogizes the operation frequency of each function with respect to the plurality of functions of the air conditioner 10, so that it is possible to promote the discovery of functions that are potentially useful for the user.

Therefore, the air conditioning system 1 according to the first embodiment can display operation icons of a plurality of functions convenient for the user in an appropriate order convenient for the user when the user controls the air conditioner 10 by looking at the operation icons displayed on the terminal display unit 22 of the operation terminal 20. Therefore, in the air conditioning system 1, when the user looks at the terminal display unit 22 of the operation terminal 20, it is possible to obtain an effect that the function of the air conditioner 10 that is convenient for the user and can be controlled from the operation terminal 20 is visually easily understood.

The configurations described in the above-mentioned embodiment indicate examples. The configurations can be combined with another well-known technique, and some of the configurations can be omitted or changed in a range not departing from the gist.

1. A home appliance control system comprising:
a home appliance;
an operation terminal including a display to display a plurality of operation icons individually corresponding to a plurality of functions of the home appliance in association with control instruction information indicating execution of the functions; and
a server to infer an operation frequency of each function with respect to the plurality of functions based on installation information of the home appliance including information regarding an environment of a location of the home appliance and information regarding a status of use of the home appliance, and determine display positions of the plurality of operation icons on the display based on the operation frequency of each function inferred.

2. The home appliance control system according to claim 1, wherein
the server includes a learning device including:
a first data acquisition unit to acquire learning data including information on the operation frequency of each function with respect to the plurality of functions, model information that is information on a model of the home appliance, and the installation information; and
a model generation unit to generate a learned model for determining display positions of the plurality of operation icons on the display from the model information and the installation information using the learning data.

3. The home appliance control system according to claim 2, wherein
the model generation unit classifies a plurality of pieces of the learning data acquired by the first data acquisition unit by model based on the model information, and generates the learned model using the learning data classified by model.

4. The home appliance control system according to claim 2, wherein
the model generation unit selects a plurality of pieces of the learning data acquired by the first data acquisition unit based on characteristics of the functions, and generates the learned model using the learning data selected based on the characteristics of the functions.

5. The home appliance control system according to claim 2, wherein
the learned model is a learned model for inferring an operation frequency of each function with respect to the plurality of functions for determining display positions of the plurality of operation icons on the display.

6. The home appliance control system according to claim 1, wherein
the server includes an inference device including:
a second data acquisition unit to acquire model information that is information regarding a model of the home appliance, and installation information of the home appliance that is information regarding an environment of a location of the home appliance or information regarding a status of use of the home appliance; and
an inference unit to output an operation frequency of each function with respect to the plurality of functions using a learned model for inferring an operation frequency of each function with respect to the plurality of functions for determining display positions of the plurality of operation icons on the display from the model information and the installation information.

7. The home appliance control system according to claim 6, wherein
the server determines display positions of the plurality of operation icons on the display based on the operation frequency of each function with respect to the plurality of functions output by the inference unit.

8. The home appliance control system according to claim 1, wherein
the home appliance is an air conditioner.

9. An operation terminal constituting a home appliance control system including a home appliance, a server, and an operation terminal and remotely operating the home appliance, the operation terminal being configured to transmit control instruction information for controlling the home appliance to the home appliance, the operation terminal comprising:
a display to display a plurality of operation icons individually corresponding to a plurality of functions of the home appliance in association with the control instruction information; and
terminal control circuitry to cause the display to display the plurality of operation icons, wherein
the terminal control circuitry
receives display position information transmitted from the server, the display position information being information on display positions of the plurality of operation icons on the display; and
when current display positions of the plurality of operation icons on the display are different from display positions of the plurality of operation icons indicated in the display position information, causes the display to display the plurality of operation icons at the display positions of the plurality of operation icons indicated in the display position information.

10. The operation terminal according to claim 9, wherein
the home appliance is an air conditioner.

11. A server constituting a home appliance control system including: a home appliance; an operation terminal including a display to display a plurality of operation icons individually corresponding to a plurality of functions of the home appliance in association with control instruction information indicating execution of the functions; and the server, the home appliance control system being configured to remotely operate the home appliance, the server comprising
server control circuitry to infer an operation frequency of each function with respect to the plurality of functions based on installation information of the home appliance including information regarding an environment of a location of the home appliance and information regarding a status of use of the home appliance, and determine display positions of the plurality of operation icons on the display based on the operation frequency of each function inferred.

12. The server according to claim 11, comprising
a learning device including:
a first data acquisition unit to acquire learning data including information on the operation frequency of each function with respect to the plurality of functions, model information that is information on a model of the home appliance, and the installation information; and
a model generation unit to generate a learned model for determining display positions of the plurality of operation icons on the display from the model information and the installation information using the learning data.

13. The server according to claim 12, wherein
the model generation unit classifies a plurality of pieces of the learning data acquired by the first data acquisition unit by model based on the model information, and generates the learned model using the learning data classified by model.

14. The server according to claim 12, wherein
the model generation unit selects a plurality of pieces of the learning data acquired by the first data acquisition unit based on characteristics of the functions, and generates the learned model using the learning data selected based on the characteristics of the functions.

15. The server according to claim 12, wherein
the learned model is a learned model for inferring an operation frequency of each function with respect to the plurality of functions for determining display positions of the plurality of operation icons on the display.

16. The server according to claim 11, comprising
an inference device including:
a second data acquisition unit to acquire model information that is information regarding a model of the home appliance, and installation information of the home appliance that is information regarding an environment of a location of the home appliance or information regarding a status of use of the home appliance; and
an inference unit to output an operation frequency of each function with respect to the plurality of functions using a learned model for inferring an operation frequency of each function with respect to the plurality of functions for determining display positions of the plurality of operation icons on the display unit from the model information and the installation information.

17. The server according to claim 16, wherein
the server control circuitry determines display positions of the plurality of operation icons on the display based on the operation frequency of each function with respect to the plurality of functions output by the inference unit.

18. The server according to claim 11, wherein
the home appliance is an air conditioner.
